(19) United States
(12) Patent Application Publication
(10) Pub. No.: US 2026/0104514 A1
(43) Pub. Date: Apr. 16, 2026

(54) POSITIONING TERMINAL

(71) Applicant: SEIKO EPSON CORPORATION, Tokyo (JP)

(72) Inventor: Hiroshi UOZUMI, MATSUMOTO-SHI (JP)

(73) Assignee: SEIKO EPSON CORPORATION, Tokyo (JP)

(21) Appl. No.: 19/357,105

(22) Filed: Oct. 14, 2025

(30) Foreign Application Priority Data
Oct. 16, 2024 (JP) 2024-180624

(51) Int. Cl. G01S 19/25; G01S 19/33

(52) U.S. Cl. CPC G01S 19/258; G01S 19/33

(57) ABSTRACT

A positioning terminal including a first reception unit that receives a first satellite signal having a first chip rate, a second reception unit that receives a second satellite signal having a second chip rate higher than the first chip rate, a first storage unit that stores the first satellite signal, a first correlation processing unit that performs correlation processing for the first satellite signal stored in the first storage unit, a second correlation processing unit that sequentially performs correlation processing for the second satellite signal received by the second reception unit, and a control unit that tracks the first satellite signal and the second satellite signal based on a result of the correlation processing of the first correlation processing unit and a result of the correlation processing of the second correlation processing unit.

The present application is based on, and claims priority from JP Application Serial Number 2024-180624, filed Oct. 16, 2024, the disclosure of which is hereby incorporated by reference herein in its entirety.

### BACKGROUND

### TECHNICAL FIELD

The present disclosure relates to a positioning terminal.

### RELATED ART

WO 2019/155703 describes a satellite positioning signal reception device including a GNSS reception circuit that functions as a master and receives an L1 signal and performs satellite capturing and satellite tracking to acquire navigation data and satellite observation values and a GNSS reception circuit that functions as a slave and receives an L2/L5 signal and performs satellite capturing and satellite tracking to acquire navigation data and satellite observation values, the master GNSS reception circuit performing positioning calculation using the L1 navigation data and the satellite observation values acquired by itself and the L2/L5 navigation data and the satellite observation values transferred from the slave GNSS reception circuit.

WO 2019/155703 is an example of the related art.

In the satellite positioning signal reception device described in WO 2019/155703, since the master GNSS reception circuit and the slave GNSS reception circuit have the same configuration, there is no difference between processing of the L1 signal having a relatively low chip rate and processing of the L5 signal having a relatively high chip rate. There is a problem in optimization of a processing load and a circuit size.

### SUMMARY

According to an aspect of the present disclosure, there is provided a positioning terminal including:

a first reception unit configured to receive a first satellite signal having a first chip rate transmitted from a first satellite;

a second reception unit configured to receive a second satellite signal having a second chip rate higher than the first chip rate, the second satellite signal being transmitted from the first satellite;

a first storage unit configured to store the first satellite signal for a time period equal to or longer than one cycle of an identification code of the first satellite included in the first satellite signal received by the first reception unit;

a first correlation processing unit configured to perform correlation processing for the first satellite signal stored in the first storage unit;

a second correlation processing unit configured to sequentially perform correlation processing for the second satellite signal received by the second reception unit; and

a control unit configured to track the first satellite signal and the second satellite signal based on a result of the correlation processing of the first correlation processing unit and a result of the correlation processing of the second correlation processing unit.

### BRIEF DESCRIPTION OF THE DRAWINGS

FIG. 1 is a diagram illustrating a configuration example of a positioning terminal in a first embodiment.

FIG. 2 is a diagram illustrating a configuration of a navigation message in an L1 band in a GPS.

FIG. 3 is a diagram illustrating a configuration of a navigation message in an L5 band in the GPS.

FIG. 4 is a flowchart illustrating an example of a procedure of processing of the positioning terminal in the first embodiment.

FIG. 5 is a diagram illustrating a configuration example of a positioning terminal in a second embodiment.

FIG. 6 is a flowchart illustrating an example of a procedure of processing of the positioning terminal in the second embodiment.

### DESCRIPTION OF EMBODIMENTS

Preferred embodiments of the present disclosure are explained in detail below with reference to the drawings. Note that the embodiments explained below do not unreasonably limit the content of the present disclosure described in the claims. Not all of the components explained below are always essential elements of the present disclosure.

### Embodiments

### Configuration of a Positioning Terminal

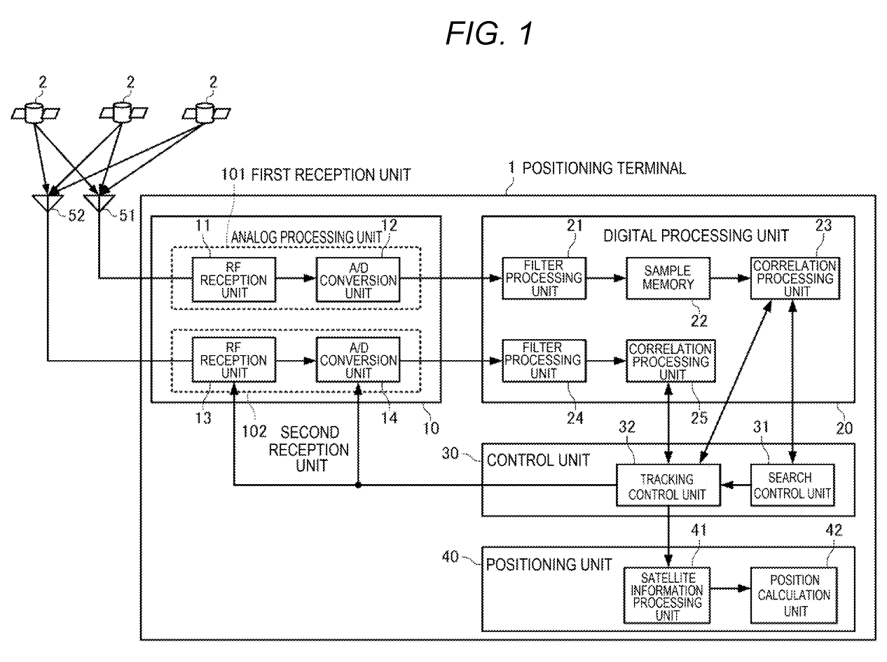

FIG. 1 is a diagram illustrating a configuration example of a positioning terminal 1 in a first embodiment. As explained in detail below, the positioning terminal 1 receives satellite signals transmitted from satellites 2 and performs positioning based on the received satellite signals.

As illustrated in FIG. 1, the positioning terminal 1 in the first embodiment includes antennas 51 and 52, an analog processing unit 10, a digital processing unit 20, a control unit 30, and a positioning unit 40. The positioning terminal 1 may have a configuration in which some of the elements illustrated in FIG. 1 are omitted or changed or other elements are added.

The antennas 51 and 52 are antennas that receive various radio waves including satellite signals transmitted from each of a plurality of satellites 2. The satellites 2 are artificial satellites orbiting a predetermined orbit above the earth and configure a part of a GNSS. GNSS is an abbreviation of Global Navigation Satellite System. Examples of the GNSS include GPS, QZSS, EGNOS, GLONASS, GALILEO, and BeiDou. GPS is an abbreviation of Global Positioning System. QZSS is an abbreviation of Quasi Zenith Satellite System. EGNOS is an abbreviation of European Geostationary Navigation Overlay Service. GLONASS is an abbreviation of Global Navigation Satellite System. Hereinafter, a case in which a satellite system to which the satellites 2 belong is a GPS is explained as an example.

The satellites 2 transmit, to the ground, satellite signals in which navigation messages are superimposed on radio waves in a plurality of frequency bands such as an L1 band having 1.57542 GHz as a center frequency and an L2 band having 1.22760 GHz as a center frequency. In the GPS, approximately thirty satellites 2 are present. In order to identify from which satellite 2 a satellite signal is transmitted, a satellite signal in the L1 band includes an identification code formed by a specific pattern of 1023 chips. The identification code in the L1 band is called C/A code. The chips are either + 1 or - 1, appear like a random pattern, and are repeated at a cycle of 1 ms. C/A is an abbreviation of Coarse/Acquisition Code. As explained above, a chip rate of the satellite signal in the L1 band is 1.023 Mcps (= 1023 chips/1 ms).

Some of the satellites 2 also transmit, to the ground, satellite signals in which navigation messages are superimposed on radio waves in the L5 band having 1.17645 GHz as a center frequency. A satellite signal in the L5 band includes an identification code formed by a specific pattern of 10230 chips. In the identification code, as in the C/A code, chips are either + 1 or - 1, appear like a random pattern, and are repeated at a cycle of 1 ms. As explained above, the chip rate of the satellite signal in the L5 band is 10.23 Mcps (= 10230 chips/1 ms), which is ten times the chip rate of the satellite signal in the L1 band.

As illustrated in FIG. 1, the analog processing unit 10 includes an RF reception unit 11, an A/D conversion unit 12, an RF reception unit 13, and an A/D conversion unit 14. The RF reception unit 11 is coupled to the antenna 51 and receives a first satellite signal having a first chip rate superimposed on a radio wave received by the antenna 51. The A/D conversion unit 12 converts the first satellite signal received by the RF reception unit 11 into a digital signal. The RF reception unit 13 is coupled to the antenna 52 and receives a second satellite signal having a second chip rate superimposed on a radio wave received by the antenna 52. The A/D conversion unit 14 converts the second satellite signal received by the RF reception unit 13 into a digital signal.

As explained above, the RF reception unit 11 and the A/D conversion unit 12 configure a first reception unit 101 that receives the first satellite signal and the RF reception unit 13 and the A/D conversion unit 14 configure a second reception unit 102 that receives the second satellite signal. In the present embodiment, the second chip rate of the second satellite signal is higher than the first chip rate of the first satellite signal. For example, the first satellite signal and the second satellite signal are transmitted from one satellite 2. Hereinafter, it is assumed that the first satellite signal is a satellite signal in the L1 band of the GPS and the second satellite signal is a satellite signal in the L5 band of the GPS.

As illustrated in FIG. 1, the digital processing unit 20 includes a filter processing unit 21, a sample memory 22, a correlation processing unit 23, a filter processing unit 24, and a correlation processing unit 25.

The filter processing unit 21 performs processing of attenuating a noise component from the first satellite signal converted into the digital signal by the A/D conversion unit 12.

The sample memory 22 sequentially stores the first satellite signal in which the noise component is attenuated by the filter processing unit 21. In the present embodiment, the sample memory 22 stores the first satellite signal for a time period equal to or longer than one cycle of a C/A code included in the first satellite signal received by the first reception unit 101, that is, for a time period equal to or longer than 1 ms.

The correlation processing unit 23 performs correlation processing for the first satellite signal stored in the sample memory 22. Specifically, the correlation processing unit 23 performs, in units of one cycle of the C/A code, that is, in units of 1 ms, the correlation processing on the first satellite signal stored in the sample memory 22. In other words, the correlation processing unit 23 does not perform the correlation processing for the first satellite signal until the first satellite signal for a time period equal to or longer than 1 ms is stored in the sample memory 22.

The filter processing unit 24 performs processing of attenuating a noise component from the second satellite signal converted into the digital signal by the A/D conversion unit 14.

The correlation processing unit 25 sequentially performs correlation processing for the second satellite signal received by the second reception unit 102. Specifically, the correlation processing unit 25 sequentially performs the correlation processing for the second satellite signal in which the noise component is attenuated by the filter processing unit 24. That is, unlike the correlation processing unit 23, the correlation processing unit 25 performs the correlation processing for the second satellite signal not via a sample memory. Since the second satellite signal, which is the satellite signal in the L5 band, has a chip rate ten times that of the first satellite signal, which is the satellite signal in the L1 band, the data amount is also ten times. Since the correlation processing unit 25 sequentially performs the correlation processing for the second satellite signal, a large sample memory is unnecessary and cost can be reduced. The correlation processing unit 25 can efficiently perform the correlation processing on the second satellite signal having a high chip rate.

As illustrated in FIG. 1, the control unit 30 includes a search control unit 31 and a tracking control unit 32. The search control unit 31 causes the correlation processing unit 23 to perform correlation processing for searching for the first satellite signal. When the correlation processing for searching for the first satellite signal is instructed, the correlation processing unit 23 generates a local code having the same pattern as a pattern of the C/A codes of the satellites 2 and performs processing of correlating the C/A codes included in the first satellite signal with the local code while shifting the phase of the local code by one chip at a time. Since the satellites 2 are moving at high speed, the frequency of a radio wave in the L1 band received by the antenna 51 fluctuates within a range of approximately ± 2 kHz with respect to 1.57542 GHz according to the Doppler effect. Since a Doppler frequency, which is the frequency equivalent to the fluctuation, is a frequency offset of the first satellite signal, the correlation processing unit 23 performs the correlation processing considering the frequency offset of the first satellite signal as well.

The search control unit 31 searches for the first satellite signal based on a result of the correlation processing of the correlation processing unit 23. Specifically, when a peak of a correlation value obtained by the correlation processing of the correlation processing unit 23 is equal to or larger than a threshold, the search control unit 31 determines that the first satellite signal, a C/A code of which is a local code corresponding to the peak correlation value, has been captured. When the first satellite signal has been captured, the search control unit 31 calculates a frequency offset of the first satellite signal based on a chip rate of the first satellite signal, calculates a code phase based on the phase of the local code, and generates capturing information including the frequency offset and the code phase of the first satellite signal.

When the search control unit 31 has captured the first satellite signal, based on the capturing information generated by the search control unit 31, the tracking control unit 32 causes the correlation processing unit 23 to perform correlation processing for tracking the first satellite signal and causes the correlation processing unit 25 to perform correlation processing for tracking the second satellite signal. The tracking control unit 32 tracks the first satellite signal and the second satellite signal based on a result of the correlation processing of the correlation processing unit 23 and a result of the correlation processing of the correlation processing unit 25 and generates capturing information including frequency offsets and code phases of the satellite signals being tracked.

As explained above, the control unit 30 causes the correlation processing unit 23 to perform the correlation processing for searching for the first satellite signal, searches for the first satellite signal based on a result of the correlation processing and, when the first satellite signal has been captured, based on the capturing information of the first satellite signal, causes the correlation processing units 23 and 25 to perform the correlation processing for tracking the first satellite signal and the second satellite signal, and tracks the first satellite signal and the second satellite signal based on a result of the correlation processing.

The control unit 30 may search for the first satellite signal based on the result of the correlation processing of the correlation processing unit 23 and, when the first satellite signal has been captured, cause the second reception unit 102 to start receiving the second satellite signal. Specifically, the second reception unit 102 may have a reception mode for receiving the second satellite signal and a sleep mode for not receiving the second satellite signal. The tracking control unit 32 may switch the second reception unit 102 from the sleep mode to the reception mode when the search control unit 31 has captured the first satellite signal. In this way, since the second reception unit 102 and the filter processing unit 24 and the correlation processing unit 25 at the later stage of the second reception unit 102 stop the processing until the search control unit 31 captures the first satellite signal, power consumption is reduced.

When high-precision positioning is requested based on predetermined operation by a user, the control unit 30 may cause the correlation processing units 23 and 25 to perform the correlation processing for tracking the first satellite signal and the second satellite signal and, when high-precision positioning is not requested, the control unit 30 may cause the correlation processing unit 23 to perform the correlation processing for tracking the first satellite signal. In this case, the control unit 30 sets the second reception unit 102 to the sleep mode, whereby the second reception unit 102, the filter processing unit 24, and the correlation processing unit 25 stop the processing. Therefore, the power consumption is reduced.

When the control unit 30 has captured the first satellite signal and the second satellite signal, the positioning unit 40 performs positioning based on at least one of the first satellite signal and the second satellite signal.

As illustrated in FIG. 1, the positioning unit 40 includes a satellite information processing unit 41 and a position calculation unit 42. The satellite information processing unit 41 demodulates navigation messages superimposed on the first satellite signal and the second satellite signal based on the capturing information generated by the tracking control unit 32. Specifically, the satellite information processing unit 41 mixes local codes having the same patterns as patterns of identification codes and the satellite signals at appropriate timing based on the frequency offsets and the code phases of the satellite signals included in respective pieces of capturing information and demodulates the navigation messages including orbit information and time information of the satellites 2.

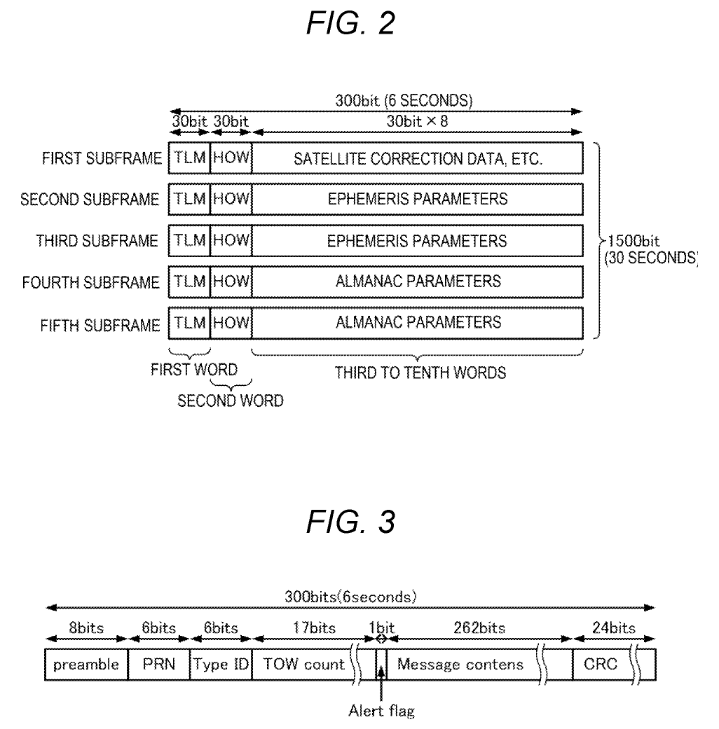

FIG. 2 is a diagram illustrating a configuration of a navigation message in the L1 band. As illustrated in FIG. 2, the navigation message in the L1 band is configured as data, one unit of which is a main frame having a total number of bits of 1,500. The main frame is divided into, from the head, first to fifth subframes that are five subframes, each of which has 300 bits. Data of one subframe is transmitted in six seconds from the satellites 2. Therefore, data of one main frame is transmitted in thirty seconds from the satellites 2.

The 300-bit data respectively included in the five subframes is divided into first to tenth words from the head with 30 bits as one word. In the subframes, the first word is a TLM word and the second word is a HOW word. TLM is an abbreviation of TeLeMetry and HOW is an abbreviation of hand Over Word. Therefore, the TLM word and the HOW word are transmitted from the satellite 2 at six second intervals.

The TLM word includes preamble data, a TLM message, reserved bits, and parity data.

The HOW word includes time information called TOW or Z count. TOW is an abbreviation of Time Of Week. Z count data is set such that an elapsed time from 0 o'clock on Sunday every week is displayed in seconds and is reset to 0 at 0 o'clock on Sunday next week. That is, the Z count data is information in units of seconds indicated every week from the beginning of the week and the elapsed time is a number represented in units of 1.5 seconds. Here, the Z count data indicates information concerning time when a leading bit of the next subframe data is transmitted. For example, Z count data of the first subframe indicates information concerning time when a leading bit of the second subframe is transmitted. The HOW word also includes a 3-bit ID code indicating an ID of a subframe. More specifically, HOW words of the first to fifth subframes respectively include ID codes "001", "010", "011", "100", and "101". Time of the satellite 2 can be calculated from week number data included in the first subframe and the HOW words included in the subframes.

The third to tenth words of the first subframe include satellite correction data such as a week number, a state of the satellite 2, and a clock correction coefficient. Specifically, the third word includes the week number and the state of the satellite 2 and the eighth to tenth words include the clock correction coefficient. The third to tenth words of each of the second and third subframes include ephemeris parameters, which are detailed orbit information of the satellite 2. The third to tenth words of each of the fourth and fifth subframes include almanac parameters, which are approximate orbit information of all the satellites 2. Therefore, the satellite correction data, the ephemeris parameters, and the almanac parameters are transmitted from the satellite 2 at intervals of thirty seconds.

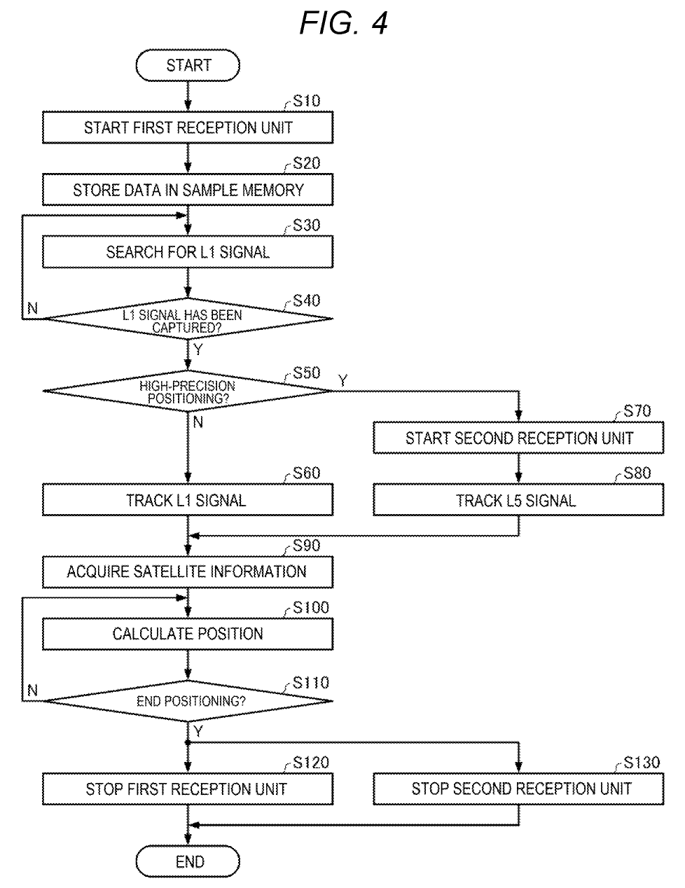

FIG. 3 is a diagram illustrating a configuration of a navigation message in the L5 band. As illustrated in FIG. 3, the navigation message in the L5 band is configured as data having a 300-bit message as one unit and is transmitted in six seconds. The 300-bit data configuring each message includes, from the head, an 8-bit preamble, a 6-bit satellite number PRN, a 6-bit message type ID, a 17-bit message TOW count, a 1-bit alert flag, 262-bit message content, and a 24-bit CRC. CRC is an abbreviation of Cyclic Redundancy Check.

The message TOW count is a TOW count simplified into 17 bits and is expressed in units of six seconds. An actual TOW count is set such that an elapsed time from 0 o'clock on Sunday every week is indicated by seconds and is reset to 0 at 0 o'clock on Sunday next week. That is, the actual TOW count is information in units of seconds indicated every week from the beginning of the week and the elapsed time is a number represented in units of 1.5 seconds. The actual TOW count simplified and expressed by 17 bits is the message TOW count.

The message content is different depending on a message type ID but includes information that is the same as or similar to the information included in the navigation message in the L1 band.

Referring back to FIG. 1, the position calculation unit 42 performs positioning calculation using orbit information and time information of four or more satellites 2 demodulated by the satellite information processing unit 41 and obtains accurate information concerning the positions and times of the antennas 51 and 52, which are reception points. Specifically, the positioning terminal 1 only has to calculate the differences between the times of the satellites 2 and the times of the reception points using the orbit information and the time information included in the satellite signals, calculate pseudo distances between the satellites 2 and the reception points based on the differences between the times, set up, using the pseudo distances, a four-dimensional equation in which three-dimensional positions (x, y, z) and times t of the reception points are four variables, and find the solution.

The satellites 2 that transmit the first satellite signal and the second satellite signal are examples of a "first satellite". The sample memory 22 is an example of a "first storage unit". The correlation processing unit 23 is an example of a "first correlation processing unit" and the correlation processing unit 25 is an example of a "second correlation processing unit".

### Processing Procedure of the Positioning Terminal

FIG. 4 is a flowchart illustrating an example of a procedure of processing of the positioning terminal 1 in the first embodiment. As illustrated in FIG. 4, first, in step S10, the control unit 30 starts the first reception unit 101. Accordingly, the first reception unit 101 starts receiving a satellite signal in the L1 band, which is the first satellite signal.

Subsequently, in step S20, the digital processing unit 20 stores, in the sample memory 22, data received by the first reception unit 101.

Subsequently, in step S30, the control unit 30 searches for a satellite signal in the L1 band based on a result of the correlation processing of the correlation processing unit 23 until the satellite signal in the L1 band is captured in step S40.

Subsequently, when capturing the satellite signal in the L1 band in step S40, when the high-precision positioning is not required in step S50, in step S60, the control unit 30 tracks the satellite signal in the L1 band based on the result of the correlation processing of the correlation processing unit 23.

On the other hand, when high-precision positioning is required in step S50, the control unit 30 starts the second reception unit 102 in step S70. Accordingly, the second reception unit 102 starts receiving a satellite signal in the L5 band, which is the second satellite signal. In step S80, the control unit 30 tracks the satellite signal in the L5 band based on a result of the correlation processing of the correlation processing unit 25.

Subsequently, in step S90, the positioning unit 40 acquires satellite information of the satellites 2 based on the tracked satellite signals.

Subsequently, in step S100, the positioning unit 40 calculates a position of the positioning terminal 1 based on the satellite information of the satellites 2 until the positioning ends in step S110.

When the positioning ends in step S110, the control unit 30 stops the first reception unit 101 in step S120, stops the second reception unit 102 in step S130, and ends the processing.

### Action Effects

As explained above, with the positioning terminal 1 in the first embodiment, for the first satellite signal having the low chip rate and a small data amount, data for the time period equal to or longer than one cycle of the identification code is stored in the sample memory 22 and the correlation processing unit 23 performs the correlation processing at high speed and, for the second satellite signal having the high chip rate and a large data amount, the correlation processing unit 25 sequentially performs the correlation processing without using a sample memory. Therefore, it is possible to reduce a processing load and a circuit size.

With the positioning terminal 1 in the first embodiment, the tracking control unit 32 can efficiently track the second satellite signal using capturing information obtained by the search control unit 31 searching for, at high speed, the first satellite signal having the low chip rate and the small data amount. Furthermore, since the search control unit 31 does not need to search for the second satellite signal having the high chip rate and the large data amount, a processing load is reduced.

With the positioning terminal 1 in the first embodiment, since the second reception unit 102 can be stopped until the tracking control unit 32 captures the first satellite signal, the power consumption is reduced.

With the positioning terminal 1 in the first embodiment, the positioning unit 40 can efficiently or highly accurately perform positioning based on the first satellite signal and the second satellite signal.

### Second Embodiment

Hereinafter, concerning a second embodiment, the same elements as those in the first embodiment are denoted by the same reference numerals and signs, explanation overlapping the explanation in the first embodiment is omitted or simplified, and differences from the first embodiment are mainly explained.

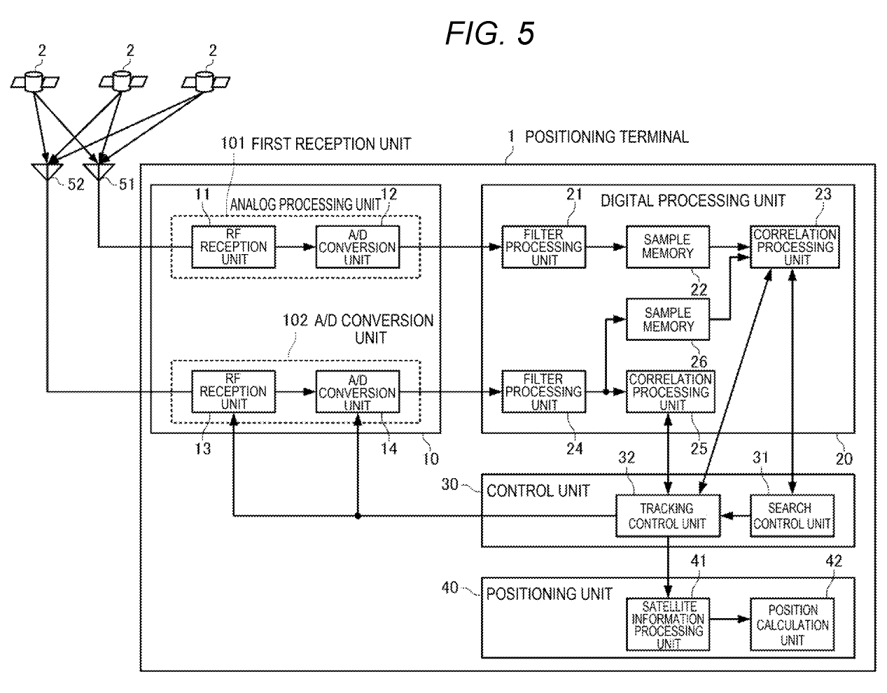

FIG. 5 is a diagram illustrating a configuration example of the positioning terminal 1 in the second embodiment. As illustrated in FIG. 5, as in FIG. 1, the positioning terminal 1 in the second embodiment includes the antennas 51 and 52, the analog processing unit 10, the digital processing unit 20, the control unit 30, and the positioning unit 40. The positioning terminal 1 may have a configuration in which some of the elements illustrated in FIG. 5 are omitted or changed or other elements are added.

As illustrated in FIG. 5, as in FIG. 1, the analog processing unit 10 includes the RF reception unit 11, the A/D conversion unit 12, the RF reception unit 13, and the A/D conversion unit 14. The RF reception unit 11 is coupled to the antenna 51 and receives a first satellite signal having a first chip rate superimposed on a radio wave received by the antenna 51. The A/D conversion unit 12 converts the first satellite signal received by the RF reception unit 11 into a digital signal.

The RF reception unit 13 is coupled to the antenna 52 and receives a second satellite signal having a second chip rate and a third satellite signal having a third chip rate superimposed on a radio wave received by the antenna 52. For example, the second reception unit 102 may switch a satellite signal to be received between the second satellite signal and the third satellite signal based on predetermined operation by a user. Specifically, the second reception unit 102 receives the second satellite signal or the third satellite signal according to an instruction from the control unit 30 based on the predetermined operation.

Further, the RF reception unit 13 may receive a fourth satellite signal having a fourth chip rate superimposed on the radio wave received by the antenna 52. For example, the second reception unit 102 may switch a satellite signal to be received between the third satellite signal, the second satellite signal, and the fourth satellite signal based on predetermined operation by the user. Specifically, the second reception unit 102 may receive the third satellite signal or may simultaneously receive the second satellite signal and the fourth satellite signal according to an instruction from the control unit 30 based on the predetermined operation.

The A/D conversion unit 14 converts a satellite signal received by the RF reception unit 13 into a digital signal.

As explained above, the RF reception unit 11 and the A/D conversion unit 12 configure the first reception unit 101 that receives the first satellite signal and the RF reception unit 13 and the A/D conversion unit 14 configure the second reception unit 102 that receives the third satellite signal or receives the second satellite signal and the fourth satellite signal. In the present embodiment, the second chip rate of the second satellite signal is higher than the first chip rate of the first satellite signal. The fourth chip rate of the fourth satellite signal is higher than the third chip rate of the third satellite signal. For example, the first satellite signal and the second satellite signal are transmitted from one satellite 2 and the third satellite signal and the fourth satellite signal are transmitted from another one satellite 2. The satellite 2 that transmits the first satellite signal and the second satellite signal belongs to a first GNSS and the satellite 2 that transmits the third satellite signal and the fourth satellite signal belongs to a second GNSS different from the first GNSS.

Hereinafter, it is assumed that the first GNSS is a GPS and the second GNSS is Beidou. The first satellite signal is a satellite signal in an L1 band of the GPS, the second satellite signal is a satellite signal in an L5 band of the GPS, the third satellite signal is a satellite signal in the L1 band of the Beidou, and the fourth satellite signal is a satellite signal in the L5 band of the Beidou.

As illustrated in FIG. 5, as in FIG. 1, the digital processing unit 20 includes the filter processing unit 21, the sample memory 22, the correlation processing unit 23, the filter processing unit 24, and the correlation processing unit 25. Further, in the second embodiment, the digital processing unit 20 includes a sample memory 26.

The filter processing unit 21 performs processing of attenuating a noise component from the first satellite signal converted into the digital signal by the A/D conversion unit 12.

The sample memory 22 sequentially stores the first satellite signal in which the noise component is attenuated by the filter processing unit 21. In the present embodiment, the sample memory 22 stores the first satellite signal for a time period equal to or longer than one cycle of a C/A code included in the first satellite signal received by the first reception unit 101, that is, for a time period equal to or longer than 1 ms.

The filter processing unit 24 performs processing of attenuating a noise component from the third satellite signal or the second satellite signal and the fourth satellite signal converted into a digital signal by the A/D conversion unit 14.

The sample memory 26 sequentially stores the third satellite signal or the second satellite signal and the fourth satellite signal in which the noise component is attenuated by the filter processing unit 24. In the present embodiment, the sample memory 26 stores the third satellite signal for a time period equal to or longer than one cycle of an identification code included in the third satellite signal received by the second reception unit 102, that is, for a time period equal to or longer than 1 ms.

The correlation processing unit 23 performs correlation processing for the first satellite signal stored in the sample memory 22. Specifically, the correlation processing unit 23 performs, in units of one cycle of the C/A code, that is, in units of 1 ms, the correlation processing on the first satellite signal stored in the sample memory 22. In other words, the correlation processing unit 23 does not perform the correlation processing for the first satellite signal until the first satellite signal for a time period equal to or longer than 1 ms is stored in the sample memory 22.

Further, the correlation processing unit 23 performs correlation processing for the third satellite signal stored in the sample memory 26. Specifically, the correlation processing unit 23 performs, in units of one cycle of an identification code, that is, in units of 1 ms, the correlation processing on the third satellite signal stored in the sample memory 26. In other words, the correlation processing unit 23 does not perform the correlation processing for the third satellite signal until the third satellite signal for a time period equal to or longer than 1 ms is stored in the sample memory 26.

The correlation processing unit 25 sequentially performs correlation processing for the second satellite signal received by the second reception unit 102. The correlation processing unit 25 sequentially performs correlation processing for the fourth satellite signal received by the second reception unit 102. Specifically, the correlation processing unit 25 respectively sequentially performs correlation processing for the second satellite signal and the fourth satellite signal in which the noise component is attenuated by the filter processing unit 24. That is, unlike the correlation processing unit 23, the correlation processing unit 25 performs the correlation processing for the second satellite signal and the fourth satellite signal not via a sample memory. Since the second satellite signal and the fourth satellite signal, which are the satellite signals in the L5 band, have higher chip rate than the first satellite signal and the third satellite signal, which are the satellite signals in the L1 band, data amounts are also larger. Since the correlation processing unit 25 sequentially performs the correlation processing for the second satellite signal and the fourth satellite signal, a large sample memory is unnecessary and cost can be reduced. The correlation processing unit 25 can efficiently perform the correlation processing on the second satellite signal and the fourth satellite signal having the high chip rate.

As illustrated in FIG. 5, as in FIG. 1, the control unit 30 includes the search control unit 31 and the tracking control unit 32. The search control unit 31 causes the correlation processing unit 23 to perform correlation processing for searching for the first satellite signal and the third satellite signal. When the correlation processing for searching for the first satellite signal and the third satellite signal is instructed, the correlation processing unit 23 performs processing of correlating C/A codes included in the first satellite signal and local codes and processing of correlating identification codes included in the third satellite signal and local codes.

The search control unit 31 searches for the first satellite signal and the third satellite signal based on a result of the correlation processing of the correlation processing unit 23. Specifically, when a peak of a correlation value obtained by the correlation processing for the first satellite signal by the correlation processing unit 23 is equal to or larger than a threshold, the search control unit 31 determines that the first satellite signal having a local code corresponding to the peak correlation value as a C/A code has been captured. Similarly, when a peak of a correlation value obtained by the correlation processing for the third satellite signal by the correlation processing unit 23 is equal to or larger than a threshold, the search control unit 31 determines that the third satellite signal having a local code corresponding to the peak correlation value as an identification code has been captured. When the first satellite signal has been captured, the search control unit 31 calculates a frequency offset of the first satellite signal based on a chip rate of the first satellite signal, calculates a code phase based on the phase of the local code, and generates capturing information including the frequency offset and the code phase of the first satellite signal. Similarly, when the third satellite signal has been captured, the search control unit 31 calculates a frequency offset of the third satellite signal based on a chip rate of the third satellite signal, calculates a code phase based on the phase of the local code, and generates capturing information including the frequency offset and the code phase of the third satellite signal.

When the search control unit 31 has captured the first satellite signal, the tracking control unit 32 causes, based on the capturing information of the first satellite signal generated by the search control unit 31, the correlation processing unit 23 to perform correlation processing for tracking the first satellite signal. The tracking control unit 32 may cause, based on the capturing information of the first satellite signal generated by the search control unit 31, the correlation processing unit 25 to perform correlation processing for tracking the second satellite signal. The tracking control unit 32 may track the first satellite signal and the second satellite signal based on a result of the correlation processing of the correlation processing unit 23 and a result of the correlation processing of the correlation processing unit 25 and generate capturing information including the frequency offsets and the code phases of the satellite signals being tracked.

As explained above, the control unit 30 may cause the correlation processing unit 23 to perform the correlation processing for searching for the first satellite signal, search for the first satellite signal based on a result of the correlation processing and, when the first satellite signal has been captured, cause, based on capturing information of the first satellite signal, the correlation processing units 23 and 25 to perform the correlation processing for tracking the first satellite signal and the second satellite signal and track the first satellite signal and the second satellite signal based on a result of the correlation processing.

When the search control unit 31 has captured the third satellite signal, the tracking control unit 32 causes, based on capturing information of the third satellite signal generated by the search control unit 31, the correlation processing unit 23 to perform correlation processing for tracking the third satellite signal. Further, the tracking control unit 32 may cause, based on capturing information of the third satellite signal generated by the search control unit 31, the correlation processing unit 25 to perform correlation processing for tracking the fourth satellite signal. The tracking control unit 32 may track the third satellite signal and the fourth satellite signal based on a result of the correlation processing of the correlation processing unit 23 and a result of the correlation processing of the correlation processing unit 25 and generate capturing information including the frequency offsets and the code phases of the satellite signals being tracked.

As explained above, the control unit 30 may cause the correlation processing unit 23 to perform the correlation processing for searching for the third satellite signal, search for the third satellite signal based on a result of the correlation processing, and when the third satellite signal has been captured, cause, based on capturing information of the third satellite signal, the correlation processing units 23 and 25 to perform the correlation processing for tracking the third satellite signal and the fourth satellite signal, and track the third satellite signal and the fourth satellite signal based on a result of the correlation processing.

When high-precision positioning is requested based on predetermined operation by the user, the control unit 30 may cause the correlation processing unit 23 to perform the correlation processing for tracking the first satellite signal and the second satellite signal and cause the correlation processing unit 25 to perform correlation processing for tracking the third satellite signal and the fourth satellite signal. When high-precision positioning is not requested based on predetermined operation by the user, the control unit 30 may cause the correlation processing unit 23 to perform the correlation processing for tracking the first satellite signal and may not cause the correlation processing unit 25 to perform the correlation processing for tracking the third satellite signal and the fourth satellite signal.

When high-precision positioning is not requested, the positioning unit 40 performs positioning based on at least one of the first satellite signal and the second satellite signal when the control unit 30 has captured the first satellite signal and the second satellite signal. When high-precision positioning is required, the positioning unit 40 may perform positioning based on at least one of the third satellite signal and the fourth satellite signal when the control unit 30 has captured the third satellite signal and the fourth satellite signal.

As illustrated in FIG. 5, as in FIG. 1, the positioning unit 40 includes the satellite information processing unit 41 and the position calculation unit 42. The satellite information processing unit 41 demodulates, based on the capturing information generated by the tracking control unit 32, the navigation message superimposed on the first satellite signal, the second satellite signal, the third satellite signal, and the fourth satellite signal. Specifically, the satellite information processing unit 41 mixes local codes having the same patterns as patterns of identification codes and the satellite signals at appropriate timing based on the frequency offsets and the code phases of the satellite signals included in respective pieces of capturing information and demodulates the navigation messages including orbit information and time information of the satellites 2.

The position calculation unit 42 performs the positioning calculation using the orbit information and the time information of the four or more satellites 2 demodulated by the satellite information processing unit 41 and obtains accurate information concerning the positions and times of the antennas 51 and 52, which are reception points.

The satellite 2 that transmits the first satellite signal and the second satellite signal is an example of a "first satellite" and the satellite 2 that transmits the third satellite signal and the fourth satellite signal is an example of a "second satellite". The sample memory 22 is an example of a "first storage unit" and the sample memory 26 is an example of a "second storage unit". The correlation processing unit 23 is an example of a "first correlation processing unit" and the correlation processing unit 25 is an example of a "second correlation processing unit".

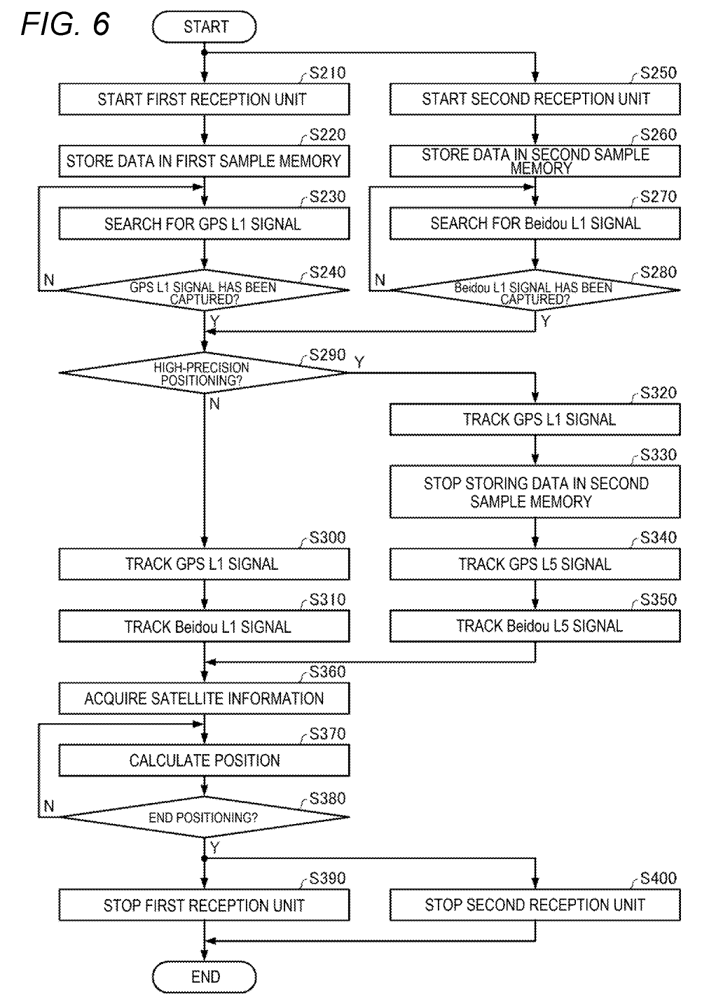

FIG. 6 is a flowchart illustrating an example of a procedure of processing of the positioning terminal 1 in the second embodiment. As illustrated in FIG. 6, first, in step S210, the control unit 30 starts the first reception unit 101. Accordingly, the first reception unit 101 starts receiving a satellite signal in the L1 band of the GPS, which is the first satellite signal.

Subsequently, in step S220, the digital processing unit 20 stores data received by the first reception unit 101 in the sample memory 22, which is a first sample memory.

Subsequently, in step S230, the control unit 30 searches for a satellite signal in the L1 band of the GPS based on a result of the correlation processing of the correlation processing unit 23 until the satellite signal in the L1 band of the GPS is captured in step S240.

In step S250, the control unit 30 starts the second reception unit 102. Accordingly, the second reception unit 102 starts receiving a satellite signal in the L1 band of Beidou, which is the third satellite signal.

Subsequently, in step S260, the digital processing unit 20 stores data received by the second reception unit 102 in the sample memory 26, which is a second sample memory.

Subsequently, in step S270, the control unit 30 searches for the satellite signal in the L1 band of the Beidou based on a result of the correlation processing of the correlation processing unit 23 until the satellite signal in the L1 band of the Beidou is captured in step S280.

Subsequently, when capturing the satellite signal in the L1 band of the GPS in step S240 and capturing the satellite signal in the L1 band of the Beidou in step S280, in step S290, when high-precision positioning is not requested, in step S300, the control unit 30 tracks the satellite signal in the L1 band of the GPS based on the result of the correlation processing of the correlation processing unit 23. Further, in step S310, the control unit 30 tracks the satellite signal in the L1 band of the Beidou based on the result of the correlation processing of the correlation processing unit 23.

On the other hand, when high-precision positioning is requested in step S290, the control unit 30 tracks the satellite signal in the L1 band of the GPS in step S320. In step S330, the digital processing unit 20 stops storing data in the sample memory 26, which is the second sample memory. The control unit 30 tracks a satellite signal in the L5 band of the GPS, which is the second satellite signal, in step S340 and tracks a satellite signal in the L5 band of Beidou, which is the fourth satellite signal, in step S350.

Subsequently, in step S360, the positioning unit 40 acquires satellite information of the satellites 2 based on the satellite signals being tracked.

Subsequently, in step S370, the positioning unit 40 calculates a position of the positioning terminal 1 based on the satellite information of the satellites 2 until the positioning ends in step S380.

When the positioning ends in step S380, the control unit 30 stops the first reception unit 101 in step S390, stops the second reception unit 102 in step S400, and ends the processing.

With the positioning terminal 1 in the second embodiment explained above, for the first satellite signal and the third satellite signal having low chip rates and small data amounts, data for a time period equal to or longer than one cycle of an identification code is stored in the sample memories 22 and 26, and the correlation processing unit 23 performs correlation processing at high speed and, for the second satellite signal and the fourth satellite signal having high chip rates and large data amounts, the correlation processing unit 25 sequentially performs the correlation processing without using a sample memory. Therefore, it is possible to reduce a processing load and a circuit size.

With the positioning terminal 1 in the second embodiment, the tracking control unit 32 can efficiently track the second satellite signal and the fourth satellite signal using capturing information obtained by the search control unit 31 searching for the first satellite signal and the third satellite signal having low chip rates and small data amounts at high speed. Further, since the search control unit 31 does not need to search for the second satellite signal and the fourth satellite signal having high chip rates and large data amounts, a processing load is reduced.

With the positioning terminal 1 in the second embodiment, the positioning unit 40 can efficiently or highly accurately perform positioning based on the first satellite signal and the second satellite signal of the first GNSS and the third satellite signal and the fourth satellite signal of the second GNSS.

The present disclosure is not limited to the present embodiments, and various modifications can be made within the scope of the gist of the present disclosure.

The embodiments and the modifications explained above are examples and are not limited thereto. For example, the embodiments and the modifications can be combined as appropriate.

The present disclosure includes substantially the same components as the components explained in the embodiments, for example, components having the same functions, methods, and results or components having the same objects and effects. The present disclosure includes components obtained by replacing non-essential portions of the components explained in the embodiments. The present disclosure includes components that can achieve the same action effects as or components that can achieve the same objects as those of the components explained in the embodiments. The present disclosure includes components obtained by adding a publicly-known technique to the components explained in the embodiments.

The following contents are derived from the embodiments and the modifications explained above.

According to an aspect of the present disclosure, there is provided a positioning terminal including:

a first reception unit configured to receive a first satellite signal having a first chip rate transmitted from a first satellite;

a second reception unit configured to receive a second satellite signal having a second chip rate higher than the first chip rate, the second satellite signal being transmitted from the first satellite;

a first storage unit configured to store the first satellite signal for a time period equal to or longer than one cycle of an identification code of the first satellite included in the first satellite signal received by the first reception unit;

a first correlation processing unit configured to perform correlation processing for the first satellite signal stored in the first storage unit;

a second correlation processing unit configured to sequentially perform correlation processing for the second satellite signal received by the second reception unit; and

a control unit configured to track the first satellite signal and the second satellite signal based on a result of the correlation processing of the first correlation processing unit and a result of the correlation processing of the second correlation processing unit.

With the positioning terminal, for the first satellite signal having the low chip rate and a small data amount, data for the time period equal to or longer than one cycle of the identification code is stored in the storage unit and the correlation processing is performed at high speed and, for the second satellite signal having the high chip rate and a large data amount, the correlation processing is sequentially performed without using the storage unit. Therefore, it is possible to reduce a processing load and a circuit size.

In the positioning terminal according to the aspect, the control unit may cause the first correlation processing unit to perform correlation processing for searching for the first satellite signal, search for the first satellite signal based on a result of the correlation processing, and, when the first satellite signal was captured, based on capturing information of the first satellite signal, cause the first correlation processing unit and the second correlation processing unit to perform correlation processing for tracking the first satellite signal and the second satellite signal.

With the positioning terminal, it is possible to efficiently track the second satellite signal using the capturing information obtained by searching for, at high speed, the first satellite signal having the low chip rate and the small data amount and, since it is unnecessary to search for the second satellite signal having the high chip rate and the large data amount, the processing load is reduced.

In the positioning terminal according to the aspect, the control unit may search for the first satellite signal based on a result of the correlation processing of the first correlation processing unit and, when the first satellite signal was captured, cause the second reception unit to start receiving the second satellite signal.

With the positioning terminal, since a search of the second satellite signal is unnecessary and a storage unit that stores the second satellite signal is also unnecessary, the processing load and a circuit size are reduced. With the positioning terminal, since the second reception unit can be stopped until the control unit captures the first satellite signal, power consumption is reduced.

The positioning terminal according to the aspect may further include a positioning unit configured to perform positioning based on at least one of the first satellite signal and the second satellite signal captured by the control unit.

With the positioning terminal, it is possible to efficiently or highly accurately perform positioning based on at least one of the first satellite signal and the second satellite signal.

In the positioning terminal according to the aspect,

the first satellite may belong to a first GNSS,

the second reception unit may receive a third satellite signal transmitted from a second satellite belonging to a second GNSS different from the first GNSS, and

the first correlation processing unit may perform correlation processing for the third satellite signal.

With the positioning terminal, it is possible to efficiently or highly accurately perform positioning using satellite signals of two GNSSs.

The positioning terminal according to the aspect may further include a second storage unit configured to store the third satellite signal for a time period equal to or longer than one cycle of an identification code of the second satellite, the third satellite signal being received by the second reception unit, and

the first correlation processing unit may perform the correlation processing for the third satellite signal stored in the second storage unit.

With the positioning terminal, for the third satellite signal as well, it is possible to store data for the time period equal to or longer than one cycle of the identification code in the storage unit and perform the correlation processing at high speed.

In the positioning terminal according to the aspect, the second reception unit may switch a satellite signal to be received between the second satellite signal of the first satellite and the third satellite signal of the second satellite based on predetermined operation.

With the positioning terminal, since the satellite signal received by the second reception unit can be switched, versatility is improved.

What is claimed is:

1. A positioning terminal comprising:
a first reception unit configured to receive a first satellite signal having a first chip rate transmitted from a first satellite;
a second reception unit configured to receive a second satellite signal having a second chip rate higher than the first chip rate, the second satellite signal being transmitted from the first satellite;
a first storage unit configured to store the first satellite signal for a time period equal to or longer than one cycle of an identification code of the first satellite included in the first satellite signal received by the first reception unit;
a first correlation processing unit configured to perform correlation processing for the first satellite signal stored in the first storage unit;
a second correlation processing unit configured to sequentially perform correlation processing for the second satellite signal received by the second reception unit; and
a control unit configured to track the first satellite signal and the second satellite signal based on a result of the correlation processing of the first correlation processing unit and a result of the correlation processing of the second correlation processing unit.

2. The positioning terminal according to claim 1, wherein the control unit causes the first correlation processing unit to perform correlation processing for searching for the first satellite signal, searches for the first satellite signal based on a result of the correlation processing, and, when the first satellite signal was captured, based on capturing information of the first satellite signal, causes the first correlation processing unit and the second correlation processing unit to perform correlation processing for tracking the first satellite signal and the second satellite signal.

3. The positioning terminal according to claim 1, wherein the control unit searches for the first satellite signal based on a result of the correlation processing of the first correlation processing unit and, when the first satellite signal was captured, causes the second reception unit to start receiving the second satellite signal.

4. The positioning terminal according to claim 3, further comprising a positioning unit configured to perform positioning based on at least one of the first satellite signal and the second satellite signal captured by the control unit.

5. The positioning terminal according to claim 4, wherein
the first satellite belongs to a first GNSS,
the second reception unit receives a third satellite signal transmitted from a second satellite belonging to a second GNSS different from the first GNSS, and
the first correlation processing unit performs correlation processing for the third satellite signal.

6. The positioning terminal according to claim 5, further comprising a second storage unit configured to store the third satellite signal for a time period equal to or longer than one cycle of an identification code of the second satellite, the third satellite signal being received by the second reception unit, wherein
the first correlation processing unit performs the correlation processing for the third satellite signal stored in the second storage unit.

7. The positioning terminal according to claim 6, wherein the second reception unit switches a satellite signal to be received between the second satellite signal of the first satellite and the third satellite signal of the second satellite based on predetermined operation.
